(19) United States
(12) Patent Application Publication
(10) Pub. No.: US 2024/0385013 A1
(43) Pub. Date: Nov. 21, 2024

(54) CROWDSOURCE TRACKING OF VEHICLES HAVING DISABLED POSITIONING OR COMMUNICATION SYSTEMS

(71) Applicant: FORD GLOBAL TECHNOLOGIES, LLC, Dearborn, MI (US)

(72) Inventors: John R. Van Wiemeersch, Novi, MI (US); Vivekanandh Elangovan, Canton, MI (US); Tom Nelson, Plymouth, MI (US)

(21) Appl. No.: 18/197,232

(22) Filed: May 15, 2023

(51) Int. Cl. G01C 21/00

(52) U.S. Cl. CPC G01C 21/3896; G01C 21/3837

(57) ABSTRACT

A vehicle has a long-range tracking system configured to provide vehicle tracking data to be shared remotely by the long-range tracking system. A trigger monitor detects a failure of the long-range tracking system to share the vehicle tracking data remotely. A tag transceiver is configured for local wireless data transfer with client devices outside the vehicle. The tag transceiver operates independently of the long-range tracking system, and the local wireless data transfer has a range less than 100 meters. The tag transceiver is responsive to detection of the failure of the long-range tracking system by the trigger monitor to 1) perform a local area beacon exchange with one or more client devices to estimate a vehicle location, and 2) request at least one of the client devices to relay a message containing the estimated vehicle location and a predetermined identifier of the vehicle to a remote site.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention relates in general to tracking of vehicles when stolen or lost, and, more specifically, to crowd-based local tracking when long-range tracking systems have been circumvented.

The problem of motor vehicle theft is addressed at several levels by vehicle manufacturers. Security systems such as mechanical keys, wireless key fobs, access entry cards, biometric devices, keypads, and smartphone-based authentication (e.g., Phone-as-a-Key) are incorporated in vehicle designs to restrict unauthorized access and use of vehicles. Such security systems may be thwarted when a physical key is stolen or duplicated, or when a security code is accessed and cloned into a separate device, which may allow a vehicle to be driven away in an unauthorized manner (e.g., by a thief or when a user of a rental car attempts to perform unauthorized off-road activity). A vehicle can also be stolen without requiring driving access by merely towing the vehicle to a different location where the security system can be disassembled or otherwise defeated.

As a further deterrent and for the purpose of vehicle recovery, remote vehicle tracking systems and devices may often be included in a vehicle. For example, a manufacturer may provide a “mobility app” executable on a smartphone or other computing device (e.g., the FordPass® app available from Ford Motor Company, Dearborn, Michigan) to access remote features such as start/stop, lock/unlock, vehicle location report, vehicle status checks, fuel/charge level check, and other features. Vehicle location tracking may also be made available to law enforcement or other security providers to aid in vehicle recovery. However, thieves may try to circumvent the tracking feature by attacking the long-range capabilities of the vehicle needed for tracking.

These long-range tracking capabilities include geographic positioning (i.e., locating) devices and data communication devices. Geographic positioning typically utilizes a global navigation satellite system (GNSS), such as the global positioning system (GPS). A thief may disable a GPS receiver by cutting power to it (e.g., pulling a corresponding fuse from a fuse block) or by disconnecting or shielding a GPS antenna to block any incoming signals.

Tracking capabilities also depends on long-range wireless communication, typically in the form of a cellular modem for providing data communication over a widely-available cellular network or a C-V2X system which shares vehicle location data. In addition to the possibilities of cutting power or shielding or disconnecting the cellular or C-V2X antenna, a thief may also jam the cellular communications by placing a jamming GSM/CDMA/LTE transmitter adjacent to the antenna.

If long-range tracking is successfully defeated then the thief may be able to transport a stolen vehicle to a location where the vehicle battery can be disconnected and other measures taken to remove the tracking capabilities.

### SUMMARY OF THE INVENTION

In one aspect of the invention, a vehicle comprises a long-range tracking system configured to provide vehicle tracking data to be shared remotely by the long-range tracking system. A trigger monitor detects a failure of the long-range tracking system to share the vehicle tracking data available remotely. A tag transceiver is configured for local wireless data transfer with client devices outside the vehicle. The tag transceiver operates independently of the long-range tracking system, and the local wireless data transfer has a range less than 100 meters. The tag transceiver is responsive to detection of the failure of the long-range tracking system by the trigger monitor to 1) perform a local area beacon exchange with one or more client devices to estimate a vehicle location, and 2) request at least one of the client devices to relay a message containing the estimated vehicle location and a predetermined identifier of the vehicle to a remote site.

### BRIEF DESCRIPTION OF THE DRAWINGS

FIG. 1 is a schematic diagram showing a conventional vehicle tracking system.

FIG. 2 is a block diagram showing a vehicle having electronic systems configured according to an embodiment of the invention.

FIG. 3 is a schematic diagram showing interactions between a host vehicle and client agents according to an embodiment.

FIG. 4 is a flowchart showing an embodiment of a method for triggering a tracking function based on short-range wireless communication.

FIG. 5 is a flowchart showing an embodiment of a tracking method based on short-range wireless communication of the host vehicle and long-range communication by client agents.

### DETAILED DESCRIPTION OF PREFERRED EMBODIMENTS

In preferred embodiments of the invention, short-range wireless communication is utilized by a compromised vehicle to achieve vehicle tracking with the assistance of other nearby resources. As used herein, vehicle means any form of mobility (such as, car, truck, bus, boat, moped, motorcycle, and others). Since available short-range systems are typically present on modern vehicles for purposes related to vehicle security and access control, they may usually receive electrical power on a same branch circuit as the electronic modules which actually operate the vehicle powertrain. Consequently, even if an unauthorized user or thief can disable long-range tracking by removing power from a cellular modem or a GNSS unit, they will not be able to depower the short-range communication devices without also disabling the driving operations of the vehicle. For example, the thief cannot jam or depower a Bluetooth® Low Energy (BLE) node or disconnect NFC card-reader antennas without also losing the ability to start and drive the vehicle. Therefore, there is a high likelihood that short-range communication will continue to be available during a vehicle theft.

In some embodiments, when tampering is detected for any devices involved in long-range tracking then a fallback tracking feature is activated which relies on the vehicle's short-range wireless transceivers such as BLE or ultra-wideband (UWB) transceivers. UWB transceivers may already be present on a vehicle for use in obstacle detection and vehicle guidance functions wherein one or more UWB devices are deployed around the vehicle perimeter which can function as tags or anchors is performing time-of-flight (ToF) or other relative positioning determinations.

Triggering events for initiating the fallback tracking feature can include a detection that the cellular modem power has been removed. Loss of power can be detected by monitoring diagnostic trouble codes (DTCs) sent over a vehicle multiplex bus or by introducing a heartbeat dialog between the modem and a controller which manages the tracking function.

Use of a jamming transmitter to interfere with signal reception of any of the wireless transceivers in the vehicle may result in high levels of a received signal strength indicator (RSSI) measured at the receiver portion of a transceiver. Therefore, RSSI values measured at a GSM, LTE, CDMA, or BLE device above a respective threshold may also be used as trigger events. Conversely, shielding or blocking of an antenna may result in low levels of RSSI. Thus, RSSI values measured by a GSM, LTE, CDMA, or BLE device below a respective threshold may also be used as trigger events. However, low RSSI values may need to be cross-checked with a general location of the vehicle to ensure that the remoteness of the location or other factors are not the cause of the low RSSI values (e.g., in rural areas, mountain valleys, etc.)

Loss of GPS data may also be used as a trigger event. Even in poor reception areas when there is insufficient GPS data to determine a location, one or two satellites are at least detectable. If no GPS data at all is coming in, then the GPS module or antenna may have been tampered with.

Once triggered, the fallback tracking is initiated which enlists other devices within a short distance of the vehicle to provide data for obtaining a location fix and for remotely reporting the location and/or status of the vehicle to a user. The other devices may include smartphones in the vehicle or nearby, other motor vehicles having compatible short-range transceivers and programming (e.g., vehicles of the same manufacturer, police vehicles, or other fleet vehicles), and/or roadside infrastructure such as an ad-hoc V2I installation.

Upon the detection of tampering, the vehicle may share identifiers and tracking data sets via short range BLE and UWB to determine vehicle location. The determined location, identifiers, and other status information may be remotely shared by an enlisted nearby device via a crowdsourced tracking network (e.g., the Find My network used by Apple® smartphones).

In some embodiments, short-range communication may be provided using an integrated module which combines BLE, UWB, and NFC functionality (referred to as a BUN module). BLE is a good option for implementing a “tag transceiver” for the fallback tracking feature since it employs 37 channels of frequency hopping which makes it harder to jam. All 37 channels would have to be jammed simultaneously while being close to the transceiver. Although UWB does not frequency hop and typically works on one set of frequencies for a particular region, there may be several UWB antennas present for an obstacle detection system (e.g., as UWB “anchors”) which are spaced relatively far apart on the vehicle. The separation makes it hard to jam them all with one jammer. The vehicle could rotate communications among the different UWB transceivers in a random manner so that at least one or more would get through. Alternatively, each UWB could transmit using different ones of the available UWB channels which would be more difficult to jam.

One or more UWB anchors may include a backup battery which can provide power in the event that the main vehicle battery is disconnected. In addition, the backup battery may enable operation in the event that a vehicle enters a key-off mode which severely restricts battery power so that a sufficient charge is maintained to enable restarting of the vehicle.

A smartphone that reports back the vehicle data might be carried by the unauthorized person or persons taking the vehicle. This may enable identification and apprehension of the person(s).

Some embodiments of the invention may enable vehicle tracking in non-theft scenarios. For example, vehicles often utilize key-off load (KOL) strategies which preserve battery charge during times of extended vehicle idleness (e.g., parked at an airport) wherein quiescent current draw is reduced by deactivating certain loads after certain time periods. A KOL strategy may include the deactivation of a telematics control unit (TCU) which contains the cellular modem after 14 days of non-use of the vehicle. The battery draw by the fallback tracking use of a BUN module would be much less than that of the TCU. By triggering the fallback tracking, a user could get a location fix on their vehicle's location past the 14 day limit.

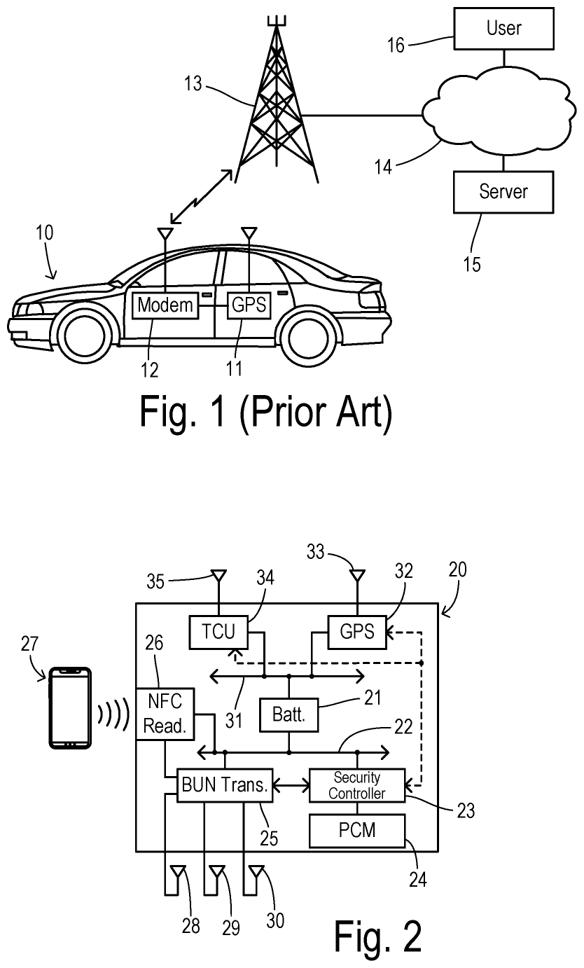

Referring to FIG. 1, a vehicle 10 includes long-range tracking systems including a GPS receiver 11 and a cellular data modem 12, each having respective antennas. For implementing a tracking system, modem 12 communicates with a data network 14 via a cellular base station 13. A central server 15 may be connected to network 14 for managing tracking and other functions. A remote user 16 may connect with network 14 to likewise access vehicle location and perform other tracking functions. Upon a failure of either GPS receiver 11 or cellular modem 12, vehicle tracking may become unavailable.

FIG. 2 shows a vehicle 20 configured to an embodiment of the present invention wherein a battery 21 with other power supply components (not shown) provides electric power to a first power supply branch 22. A security controller 23 is supplied by first branch 22. Security controller 23 is configured to provide security functions such as vehicle unlocking and restricting operation of vehicle powertrain components (e.g., engine starting and transmission unlocking) via an interconnection of security controller 23 to a powertrain control module 24. A BUN transceiver module 25 incorporating BLE, UWB, and NFC functions is also powered by first branch 22. BUN module 25 is coupled with security controller 23. With their common reliance on first power supply branch 22, whenever security controller 23 is operational then BUN transceiver module 25 would also be operational.

Bun transceiver module 25 may include near field communication (NFC) capability in cooperation with an NFC reader 26 configured to communicate with a smartphone 27 (operating as a Phone-as-a-Key device). BUN transceiver module 25 operates in a UWB mode via UWB antennas 28 and 29. A Bluetooth mode of BUN transceiver 25 operates in conjunction with a Bluetooth antenna 30.

A second power supply branch 31 from battery 21 powers a GPS receiver 32 and a cellular modem in a TCU module 34. GPS receiver 32 has a GPS antenna 33 and the cellular modem has a cellular antenna 35. Security controller 23 is coupled with GPS receiver 32 and TCU module 34 to monitoring their operation and to detect any tampering with the operation of the GPS or cellular communication functions (e.g., by removing electrical power from them). When security controller 23 detects a trigger event occurring in either of these long-range tracking system components, it uses BUN transceiver module 25 to initiate a tag transceiver function using short-range wireless communication (e.g., a BLE or UWB link to a nearby device as described below).

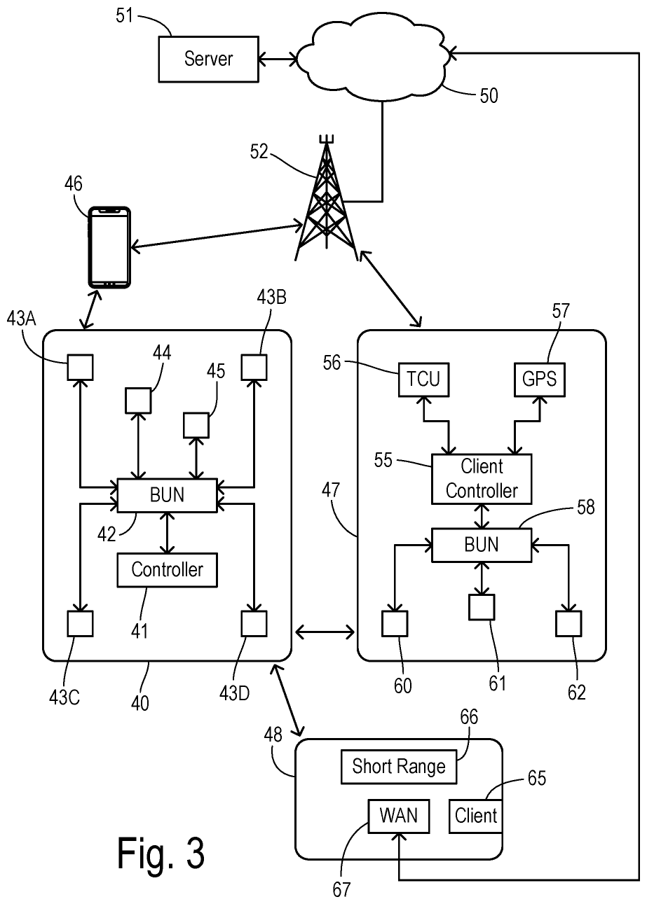

FIG. 3 shows interactions of a host vehicle 40 with nearby client devices in a fallback tracking function which uses the client devices to obtain both local positioning data and remote communications. Vehicle 40 includes a security controller 41 coupled with a BUN module 42. A plurality of UWB devices (e.g., UWB position anchors and/or tags) 43A-43D with their respective UWB antennas are deployed around vehicle 40 and are each connected to BUN module 42. BUN module 42 may also be connected to a BLE antenna 44 and an antenna 45 for providing Wi-Fi or other local area network communications. The two-way communication needed for emulating a tag transceiver may utilize any of the short-range wireless communication channels that may be available. As used herein, short-range wireless communication means channels providing local data transfer having a range of less than about 100 meters.

Local client devices (e.g., located within about 100 meters of vehicle 40) which may be enlisted to participate in fallback tracking include a smartphone 46, a motor vehicle 47, and a fixed roadside unit 48. Client devices 46-48 may communicate via a data network 50 with a remote server 51 which provides data storage and reporting of host vehicle data. For example, smartphone 46 connects to network 50 via a cellular system having a cellular base station 52. Nearby vehicle 47 includes a client controller 55 connected to a TCU module 56 and GPS receiver 57. TCU module 56 includes a cellular modem likewise able to communicate with cellular base station 52. Vehicle 47 further includes a BUN module 58 with UWB antennas 60 and 62 and a Bluetooth antenna 61 enabling short-range communication with host vehicle 40. Similarly, fixed roadside unit 48 includes a client controller 65, a short range transceiver 66 (e.g., a V2I transceiver), and a wide area network module 67 (coupled to network 50). Client controllers 55 and 65 as well as smartphone 46 are configured with a client software application that manages an interaction with host controller 41 in host vehicle 40 according to the fallback tracking features. Smartphone 46 could be carried by a pedestrian, cyclist, or a passenger in vehicles 40 or 47, for example.

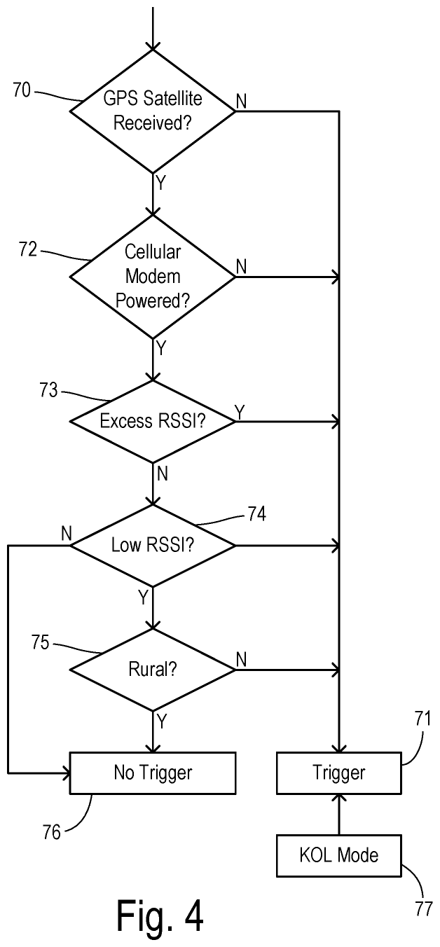

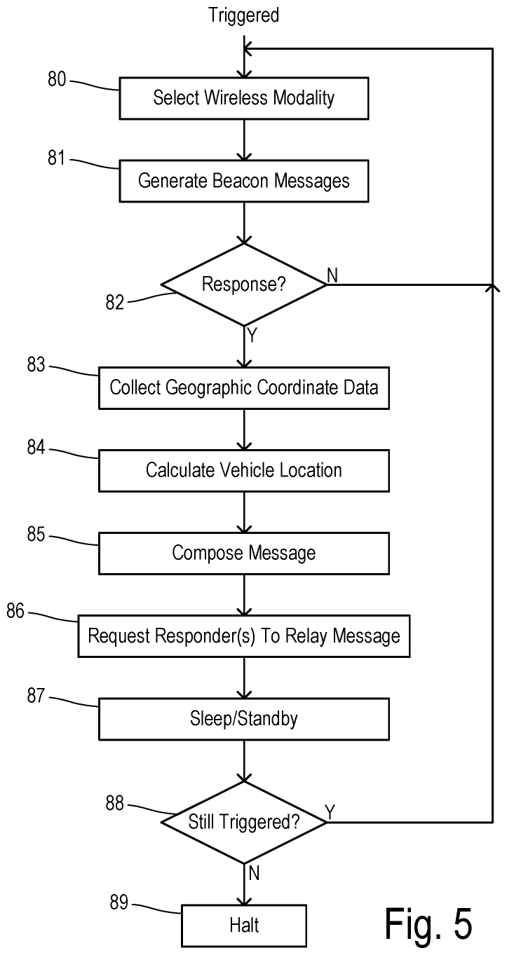

FIG. 4 shows a method for detecting presence of a trigger event. In step 70, a check is performed to determine whether at least one GPS satellite signal is being received. If not, then a trigger event is detected at step 71 (after which the short-range tracking may be initiated as shown in FIG. 5). If a GPS satellite signal is received, then the GPS antenna is not shielded. Consequently, a check is performed in step 72 to determine whether the cellular modem is receiving power. If not, then a trigger event is detected in step 71. If cellular modem power is present, then a check is performed in step 73 to determine whether there is an excess RSSI present (e.g., RSSI is greater than a threshold) in any receiver used for the long-range tracking function (e.g., cellular modem or GPS receiver). If so, then jamming may be occurring and a trigger event is detected at step 71 (the check for an excess RSSI value may be conditioned upon whether the vehicle is very close to a cellular tower, which could account for the excess RSSI). Otherwise, a check is performed in step 74 to determine whether any receiver's RSSI value is below a predetermined threshold. If not, then no trigger event is detected at step 75. Otherwise, if there is a low RSSI value then a check is performed in step 75 to determine whether the vehicle is known to be in a rural location or in another situation which would cause the low RSSI value. If not, then a trigger event is detected at step 71.

FIG. 4 also shows the potential initiation of the fallback tracking feature when power to a cellular modem or GPS receiver is deliberately cut off. For example, when a particular KOL mode is initiated at step 77 in which a TCU module is turned off, then a trigger event is signaled at step 71.

FIG. 5 shows an embodiment of the invention wherein short-range tracking is initiated after a trigger event has been detected. In step 80, a wireless modality for communication with nearby client devices is selected. For example, a UWB anchor may be randomly selected from among several present in the vehicle, or polling signals may be sent via different modalities (e.g., Bluetooth or UWB) to search for available client devices. Once a modality is selected, broadcast messages may be generated in step 81 by the host tag transceiver. A broadcast message may request a location or other data from nearby devices to obtain a geographic location of the host vehicle. A check is performed in step 82 to determine whether any responses are obtained. If not, then a wireless modality may be reselected in step 80.

Once responses are detected, the host vehicle may collect geographic coordinate data from client devices in step 83. For example, a host vehicle may communicate with multiple different client devices, each of which reports its own geographic location. In step 84, a vehicle location may be calculated (e.g., by using triangulation based on the location of nearby devices). In some embodiments, a host vehicle may only be able to adopt a geographic location of a nearby device as reported by that nearby device. In step 85, the host vehicle composes a message which includes an identifier of the host vehicle, the calculated vehicle location, and optionally other status data such as the presence of a theft detection or other information. In step 86, the host vehicle requests one or more of the nearby responder client devices to relay the message to a remote site such as a central server or to a particular user. Once the message has been sent, the security controller and/or tag transceiver of the host vehicle may be put into a sleep mode or a standby mode in step 87 to conserve battery power. The sleep or standby mode may be periodically interrupted by a wake-up period during which a check is performed in step 88 to determine whether the trigger event conditions are still present. Sleep or standby in step 87 may alternatively not be used at all. If the trigger condition exists, then further location updates may be obtained by returning to step 80. If the trigger condition no longer exists, then the method may halt at step 89.

What is claimed is:

1. A vehicle comprising:
a long-range tracking system configured to provide vehicle tracking data to be shared remotely by the long-range tracking system;
a trigger monitor detecting a failure of the long-range tracking system to share the vehicle tracking data remotely; and
a tag transceiver configured for local wireless data transfer with client devices outside the vehicle, wherein the tag transceiver operates independently of the long-range tracking system, and wherein the local wireless data transfer has a range less than 500 meters;
wherein the tag transceiver is responsive to detection of the failure of the long-range tracking system by the trigger monitor to perform a local area beacon exchange with one or more client devices to estimate a vehicle location, and to request at least one of the client devices to relay a message containing the estimated vehicle location and a predetermined identifier of the vehicle to a remote site.

2. The vehicle of claim 1 wherein the tag transceiver is comprised of a short-range wireless node using a Bluetooth protocol.

3. The vehicle of claim 1 wherein the tag transceiver is comprised of an ultra-wideband (UWB) transceiver configurable as a location anchor.

4. The vehicle of claim 1 wherein the long-range tracking system comprises a global navigation satellite system (GNSS) receiver.

5. The vehicle of claim 4 wherein the trigger monitor is coupled to the GNSS receiver, and wherein the trigger monitor detects the failure when the GNSS receiver does not detect any signals transmitted by a corresponding satellite.

6. The vehicle of claim 1 wherein the long-range tracking system comprises a cellular data modem.

7. The vehicle of claim 6 wherein the trigger monitor is coupled to the cellular data modem, and wherein the trigger monitor detects the failure when the cellular data modem is inoperable because of loss of power or disruption of signal transmission.

8. The vehicle of claim 1 wherein the trigger monitor is further responsive to initiation of a predetermined key-off load (KOL) mode in the vehicle, and wherein the tag transceiver performs the local area beacon exchange and the request to relay the message containing the estimated vehicle location and the predetermined identifier of the vehicle to the remote site when the predetermined KOL mode is initiated.

9. The vehicle of claim 1 further comprising an electrical power distribution system with multiple power supply branches, wherein the tag transceiver receives electrical power from a first power supply branch, and wherein the long-range tracking system receives electrical power from a second power supply branch.

10. The vehicle of claim 9 comprising a security controller which includes the trigger monitor and which is configured to restrict access to the vehicle according to driver authentication devices, and wherein the security controller receives electrical power from the first power supply branch so that a disconnection of power to the tag transceiver disables operation of the security controller.

11. A method of tracking a vehicle comprising the steps of:
detecting a failure of a long-range tracking system in the vehicle which is configured to remotely share vehicle tracking data;
generating local area beacon exchanges between a tag transceiver in the vehicle and one or more client devices outside the vehicle, wherein the tag transceiver is configured for local wireless data transfer with the client devices, wherein the local area beacon exchanges provide an estimated vehicle location, wherein the tag transceiver operates independently of the long-range tracking system; and
requesting at least one of the client devices to relay a message containing the estimated vehicle location and a predetermined identifier of the vehicle to a remote site.

12. The method of claim 11 wherein the tag transceiver is comprised of a short range wireless node using a Bluetooth protocol.

13. The method of claim 11 wherein the tag transceiver is comprised of an ultra-wideband (UWB) transceiver configurable as a location anchor.

14. The method of claim 11 wherein the long-range tracking system comprises a global navigation satellite system (GNSS) receiver.

15. The method of claim 14 wherein the step of detecting the failure is comprised of determining whether the GNSS receiver detects any signals transmitted by a corresponding satellite.

16. The method of claim 11 wherein the long-range tracking system comprises a cellular data modem.

17. The method of claim 16 wherein the step of detecting the failure is comprised of determining whether the cellular data modem is inoperable because of loss of power or disruption of signal transmission.

18. The method of claim 16 wherein the determination of the disruption of signal transmission is comprised of detecting an abnormal received signal strength indicator (RSSI) at the cellular data modem.

19. The method of claim 11 further comprising the steps of:
initiating a predetermined key-off load (KOL) mode in the vehicle whenever the vehicle has been unused for a predetermined period of time;
performing the local area beacon exchange and the request to relay the message containing the estimated vehicle location and the predetermined identifier of the vehicle to the remote site in response to the predetermined KOL mode.

20. The method of claim 11 wherein the vehicle includes an electrical power distribution system with multiple power supply branches, wherein the vehicle includes a security controller which detects the failure and which is configured to restrict access to the vehicle according to driver authentication devices, wherein the tag transceiver receives electrical power from a first power supply branch, wherein the long-range tracking system receives electrical power from a second power supply branch, and wherein the security controller receives electrical power from the first power supply branch so that a disconnection of power to the tag transceiver disables operation of the security controller.
